(19) United States
(12) Patent Application Publication
(10) Pub. No.: US 2008/0107299 A1
(43) Pub. Date: May 8, 2008

(54) EARPHONE

(76) Inventor: I-Ming Lin, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/556,494

(22) Filed: Nov. 3, 2006

(51) Int. Cl. H04R 25/00

(52) U.S. Cl. 381/380

(57) ABSTRACT

An earphone includes a shell, a seat, a speaker and a ring. The shell defines a sound field. The seat includes an external rim fit in the shell and an internal rim extended form the external rim. The speaker includes a terminal inserted through the internal rim. The ring is engaged with the external rim for positioning the speaker.

### BACKGROUND OF INVENTION

1. Field of Invention

The present invention relates to an earphone.

2. Related Prior Art

It could be amusement to listen to music. However, all of people do not feel like listening to the same music at the same time. In fact, some people simply do not like music. For those who would like to listen to music, earphones are useful tools for them to enjoy themselves without bothering other people near them.

As there is trend to make things smaller and lighter so that users can use them with more comfort and convenience. Earphones are no exception. There are earphones about the size of earplugs. Referring to FIGS. 6 and 7, a conventional earphone includes a shell 1 defining a space 3, a handle 2 extended from the shell 1, a speaker 4 disposed in the space 3 and a ferrule 5 engaged with the shell 1 for keeping the speaker 4 in the space 3. A wire is directed into the shell 1 through the handle 2. The wire is connected to the speaker 4. Sound and echo cannot reach a user's ear simultaneously. Therefore, the user hears a lot of noises. However, the space 3 is too small to contain other elements for improving the sound effects of the earphone.

The present invention is therefore intended to obviate or at least alleviate the problems encountered in prior art.

### SUMMARY OF INVENTION

According to the present invention, an earphone includes a shell, a seat, a speaker and a ring. The shell defines a sound field. The seat includes an external rim fit in the shell and an internal rim extended form the external rim. The speaker includes a terminal inserted through the internal rim. The ring is engaged with the external rim for positioning the speaker.

The primary advantage of the earphone according to the present invention is small in size and excellent in performance.

Other advantages and features of the present invention will become apparent from the following description referring to the drawings.

### BRIEF DESCRIPTION OF DRAWINGS

The present invention will be described through detailed illustration of the preferred embodiment referring to the drawings.

FIG. 1 is a perspective view of an earphone according to the preferred embodiment of the present invention.

FIG. 2 is an exploded view of the earphone shown in FIG. 1.

FIG. 3 is a cross-sectional view of the earphone taken along a line 3-3 shown in FIG. 1.

FIG. 4 is a cross-sectional view of the earphone taken along a line 4-4 shown in FIG. 1.

FIG. 5 is a front view of a user wearing the two earphones as shown in FIG. 1.

FIG. 6 is a perspective view of a conventional earphone.

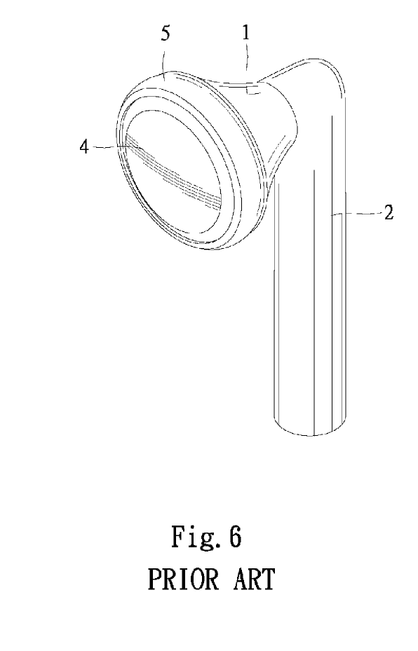

FIG. 7 is an exploded view of the earphone shown in FIG. 6.

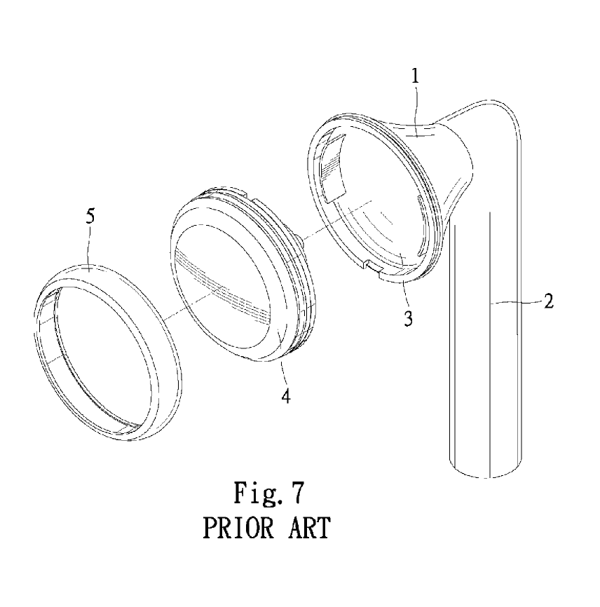

### DETAILED DESCRIPTION OF PREFERRED EMBODIMENT

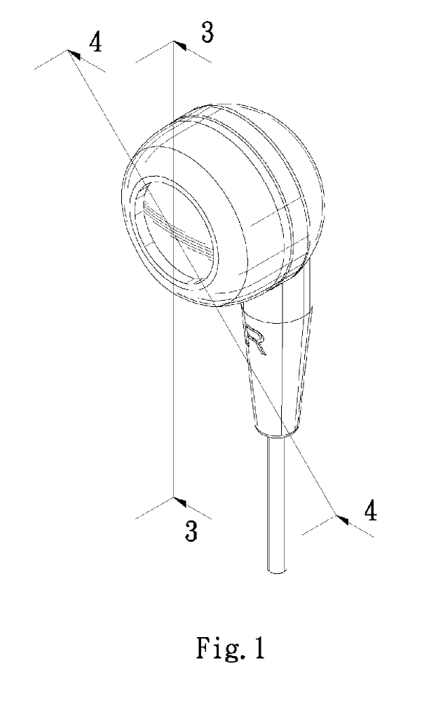

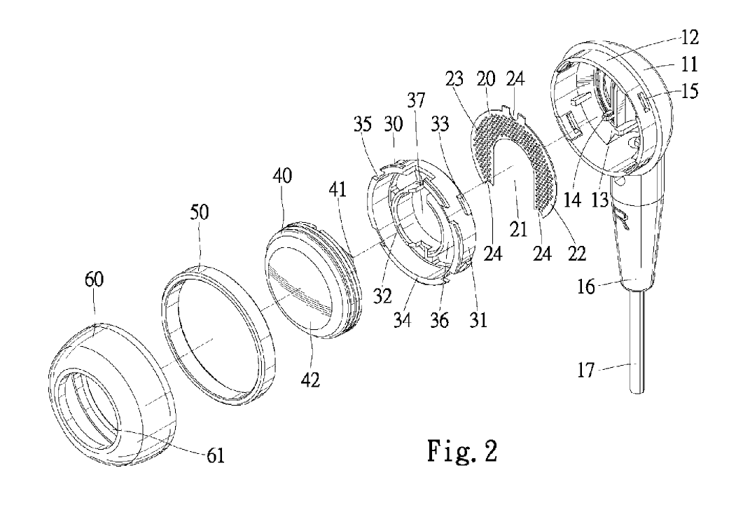

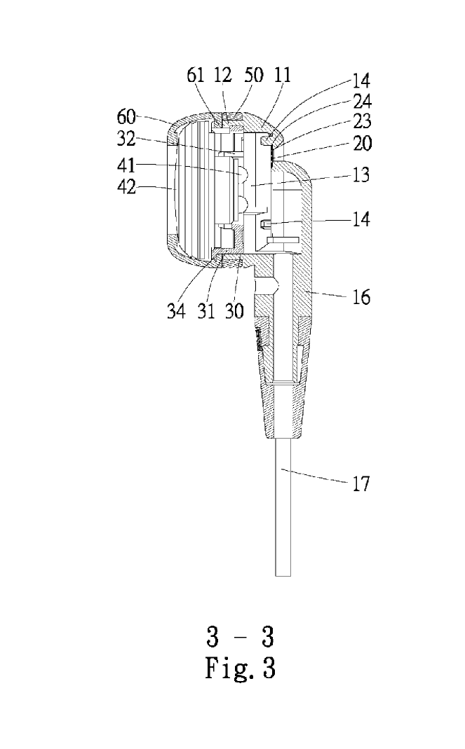

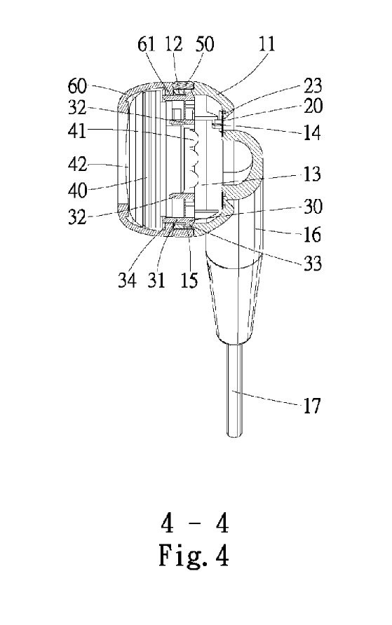

Referring to FIGS. 1 through 4, there is shown an earphone according to the preferred embodiment of the present invention.

The earphone includes a shell 11, a handle 16 extended from the shell 11, a sound-spreading plate 20 disposed in the shell 11, a seat 30 fit in the shell 11, a speaker 40 located next to the seat 30, a ferrule 50 for reinforcing the shell 11 and a ring 60 engaged with the seat 30 for positioning the speaker 40.

The shell 11 and the handle 16 are made as one piece and both of them are hollow. The shell 11 defines a sound field 13 and includes a plurality of rods 14 extended from an internal side thereof within the sound field 13. The shell 11 includes a rim 12. A plurality of slots 15 is defined in the rim 12. A wire 17 is inserted into the shell 11 through the handle 16. The wire 17 is connected to the speaker 40.

The ferrule 50 is made of metal. The ferrule 50 is provided on the rim 12 so that the former reinforces the latter. An external side of the ferrule 50 is flush with an external side of the shell 11 so that together, they make a smooth profile.

The sound-spreading strip 20 is an inverted U-shaped element defining a space 21 and a plurality of cutouts 24. A plurality of sound apertures 23 is defined in the sound-spreading strip 20. The cutouts 24 receive the rods 14 when the sound-spreading strip 20 is disposed in the shell 11 so that the sound-receiving strip 20 is precisely positioned in the shell 11. The sound-spreading strip 20 is used for at least two purposes. Firstly, it is used for decoration. Secondly, it is used to adjust the sound curve of the earphone, thus provide better sound quality.

The seat 30 is formed with an external rim 31 and an external ring 32. A space 36 is defined between the rims 31 and 32. A plurality of tabs 33 is formed on an external side of the external rim 31. A plurality of flanges 34 is formed on the external side of the external rim 31. The flanges 34 are separated from each other cutouts 35. The tabs 33 are fit in the slots 15 for firmly connecting the seat 30 to the rim 12. During the insertion of the seat 30 into the rim 12 the ferrule 50 reinforces the rim 12 and avoids breaking up of the rim 12 that would otherwise be possible. The seat 30 is used to hold the speaker 40.

The speaker 40 includes a terminal 41 on a side and a broadcasting portion 42 on an opposite side. The terminal 41 is inserted through the internal rim 32 and connected to the wire 17. The speaker 40 includes a portion for sealing the external rim 31.

The ring 60 is made of an elastic material. The ring 60 includes a rim 61 on an internal side. The rim 61 is engaged with the flanges 34 for firmly connecting the ring 60 to the seat 30 and for positioning the speaker 40. An external side of the ring 60 is flush with those of the shell 11 and the ferrule 50, so that, they make a smooth profile.

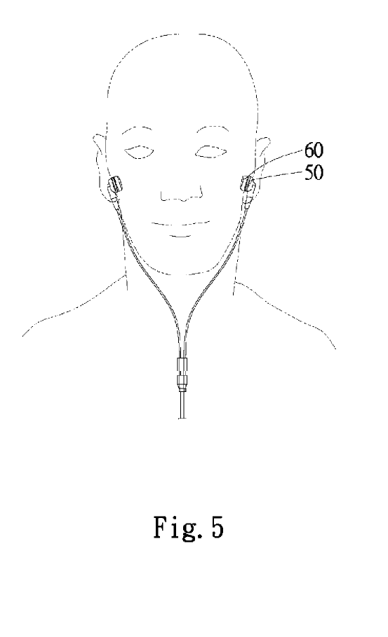

Referring to FIG. 5, there is shown a user who wearing two earphones as shown in FIGS. 1 through 4. Therefore, the user can listen to music without bothering other people near him.

The sound field 13 is defined in the shell 11 behind the speaker 40. The speaker 40 is mounted on the seat 30. When sound is produced by the speaker 40, the sound vibrates in the sound field 13 so that the sound and the echo reach a user's ear at the same time, thus provide an excellent sound effect.

The primary advantage of earphone of the present invention is small in size and excellent in performance because of the use of the sound-spreading strip 20 and the seat 30.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. An earphone comprising:
a shell defining a sound field;
a seat comprising an external rim fit in the shell and an internal rim extended form the external rim;
a speaker comprising a terminal inserted through the internal rim; and
a ring engaged with the external rim for positioning the speaker.

2. The earphone according to claim 1 comprising a sound-spreading strip disposed in the sound field.

3. The earphone according to claim 2 wherein the sound-spreading strip defines a plurality of sound apertures.

4. The earphone according to claim 2 wherein the sound-spreading strip defines a plurality of cutouts, and the shell comprises a plurality of rods inserted through the cutouts.

5. The earphone according to claim 1 wherein the shell comprises a rim for receiving the external rim of the seat.

6. The earphone according to claim 5 comprising a ferrule for reinforcing the rim of the shell.

7. The earphone according to claim 6 wherein the ferrule is made of metal.

8. The earphone according to claim 5 wherein the rim of the shell defines a plurality of slots, and the external rim of the seat comprises a plurality of tabs fit in the slots.

9. The earphone according to claim 1 wherein the external rim comprises at least one flange formed thereon, and the ring comprises a rim engaged with the flange.

10. The earphone according to claim 1 wherein the external rim comprises a plurality of flanges separated by cutouts for improving the flexibility of the flanges.
